(19) United States
(12) Patent Application Publication
(10) Pub. No.: US 2026/0115973 A1
(43) Pub. Date: Apr. 30, 2026

(54) MOLD FOR DRYING AND COMPACTING A FIBROUS PREFORM

(71) Applicant: Safran, Paris (FR)

(72) Inventors: Maxime Christian Darblade, Moissy-Cramayel (FR); Sébastien Pierre Roger Dunaud, Moissy-Cramayel (FR)

(21) Appl. No.: 19/149,829

(22) PCT Filed: Dec. 12, 2023
(86) PCT No.: PCT/EP2023/085313

§ 371 Date: Jul. 21, 2025

(30) Foreign Application Priority Data
Jan. 25, 2023 (FR) FR2300691

(51) Int. Cl. B29C 33/38; B29K 105/00; B33Y 10/00; B33Y 80/00

(52) U.S. Cl. CPC B29C 33/3814; B29C 33/3842; B29K 2105/253; B29K 2879/085; B33Y 10/00; B33Y 80/00

(57) ABSTRACT

The invention relates to a mold for drying a fibrous preform, comprising at least one part having inner faces defining a cavity of the mold, against which the fibrous preform, wetted by a wetting liquid, is intended to be brought into contact, said part having an openwork structure allowing the wetting liquid to pass through this part of the mold, the openwork part consisting of a plurality of intersecting filaments defining through-openings allowing the passage of the wetting liquid.

The present invention relates to a mold for drying, and possibly compacting, a fibrous preform. The invention finds a particularly advantageous, but not exclusive, application for the production of a turbomachine part from a woven preform.

It is known to manufacture parts of a turbomachine from a composite material comprising a fiber reinforcement structure, so-called a fibrous preform, embedded in a polymer matrix. The fibrous preform is obtained by 3D weaving by means of a Jacquard type loom, as described in documents WO-2013/088037 and FR-3062659. The loom allows to manufacture a three-dimensional (3D) preform by multi-layer weaving between a plurality of layers of warp threads and a plurality of layers of weft threads. The threads are for example carbon threads.

The preform is generally made flat, that is to say that the preform obtained at the outlet of the loom has a generally flat shape, although the thickness of the preform can vary. The preform is then shaped, according to a shaping step, for adopting a general shape close to that of the part to be manufactured. This shaping is carried out by compacting on the imprint of a mold.

The shaping challenge is to get a shape as naturally as possible without altering the weaving pattern on the surface and in the core of the preform. It is important that the fibers are malleable so as to carry out these manipulations, particularly in the thickest areas of the preform. This operation requires abundant wetting of the preform because wet fibers better slide together once lubricated by a wetting liquid, generally water.

Once shaped, the preform must be dried in order to remove the water that we do not want to keep in the mold during the injection of the resin. Indeed, the presence of water is a major drawback that could be a source of porosity in the injected part.

The operation of drying and compacting the perform are carried out using machined molds out of metal, generally aluminum. It is possible to provide “free” areas without any compacting surface or water drainage areas such as holes in the mold.

However, this type of mold may allow some humidity and/or require a significant drying time to ensure proper drying of the fibrous preform.

The objective of the invention is to effectively remedy the aforementioned drawbacks by proposing a mold for drying a fibrous preform comprising at least one part comprising internal faces defining an imprint of the mold with which the fibrous preform wetted by a wetting liquid comes into contact in order to be shaped, characterized in that said part has a lacunary structure allowing passage of the wetting liquid through said part of said mold, the part having a lacunary structure comprising a plurality of intersecting filaments defining through openings for the passage of the wetting liquid.

The invention thus allows, thanks to the presence of the part of lacunary structure, to optimize the duration and the level of drying of a preform. Indeed, during a compaction operation, the fibrous preform is mechanically wrung out by a counterform cooperating with the mold imprint and the wetting liquid can be evacuated to the outside of the mold by the part having a lacunary structure. In addition, the structure comprising a plurality of filaments is easy to manufacture, because it is intrinsically well suited to additive manufacturing by filament deposition. The invention also allows to obtain a very lacunary, that is to say very porous, structure designed to evacuate the fiber wetting liquid.

According to one embodiment of the invention, a gap between two adjacent filaments is comprised between 0.2 mm and 2 mm, or even between 0.2 mm and 1 mm.

According to one embodiment of the invention, the mold is obtained by an additive manufacturing process with filament deposition.

According to one embodiment of the invention, said mold further comprises a part having a rigid structure arranged around the part having a lacunary structure.

According to one embodiment of the invention, the part having a rigid structure has a higher density than the part having a lacunary structure.

According to one embodiment of the invention, the part having a rigid structure is made from a solid material.

According to one embodiment of the invention, the part having a lacunary structure and the part having a rigid structure form a single piece.

According to one embodiment of the invention, said mold comprises a pneumatic connection in fluid communication with the portion having a lacunary structure, the portion having a rigid structure defining a sealed envelope at least partially surrounding the portion having a lacunary structure.

According to one embodiment of the invention, the part having a lacunary structure is made from an amorphous thermoplastic polyetherimide resin.

The invention also relates to a method for drying a fibrous preform comprising at least one step of placing the fibrous preform inside a drying mold as previously defined.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and the description of its implementation and eventually contribute to its definition, wherein:

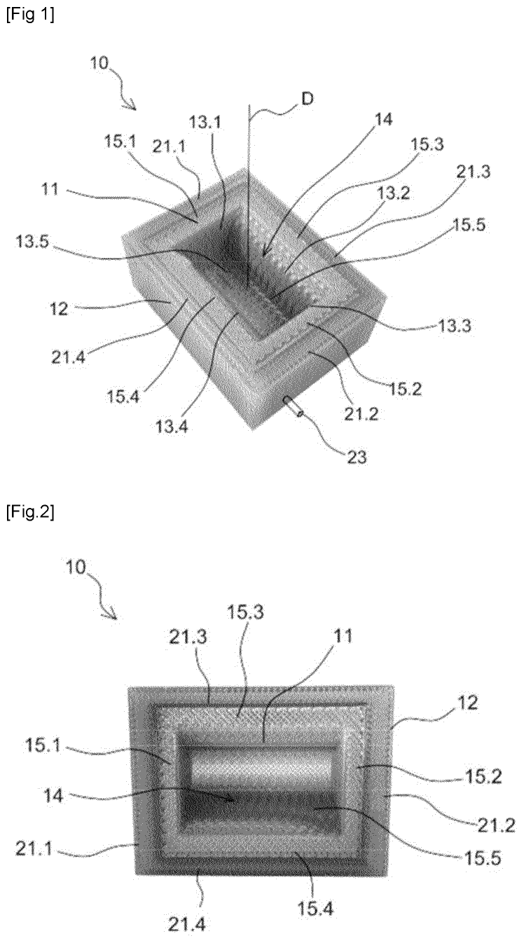

FIG. 1 is a photograph of a perspective view of a compacting and drying mold according to the invention;

FIG. 2 is a photograph of a top view of a compacting and drying mold according to the invention;

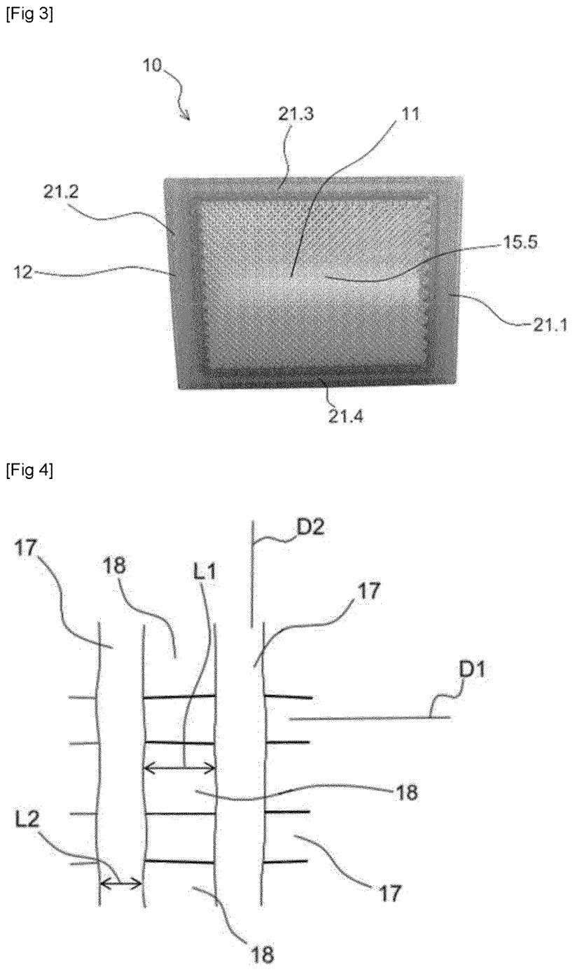

FIG. 3 is a photograph of a bottom view of a compacting and drying mold according to the invention;

FIG. 4 shows the detail of the lacunary structure of the part comprising the imprint of the compacting and drying mold according to the invention.

It should be noted that, in the figures, the structural elements and/or functional elements common to the different embodiments may have the same references. Thus, unless otherwise stated, such elements have identical structural, dimensional and material properties.

FIGS. 1, 2, and 3 show a drying and compacting mold 10 for a fibrous preform (not shown) comprising a part 11 having a lacunary structure and a part 12 as a mechanical reinforcement and/or waterproof envelope surrounding the first part 11.

The part 11 having a lacunary structure comprises internal faces 13.1-13.5 defining an imprint 14 of the mold 10 with which the fibrous preform wetted by a wetting liquid, in particular water, comes into contact in order to be shaped. The part 11 having a lacunary structure allows the passage of the wetting liquid through said part of the mold 10.

The part 12 having a rigid structure is intended in this case to ensure a force recovery during an operation of compacting the fibrous preform by means of a counterform cooperating with the imprint 14 of the mold 10. The part 12 having a rigid structure is arranged around the part 11 having a lacunary structure. The part 12 having a rigid structure has a higher density than the part 11 having a lacunary structure.

More specifically, the part 11 having a lacunary structure comprises two opposite and parallel side walls 15.1, 15.2. Each side wall 15.1, 15.2 comprises an internal face 13.1 resp. 13.3. These walls 15.1, 15.2 are connected to each other by two other opposite and generally parallel side walls 15.3, 15.4. Each side walls 15.3, 15.4 comprises an internal face 13.2 resp. 13.4. The part 11 also has a bottom wall 15.5 comprising the internal face 13.5. The part 11 having a lacunary structure thus has a parallelepiped shape open in a direction D perpendicular to the bottom 15.5 in order to receive the fibrous preform.

As illustrated in FIG. 4, the part 11 with the lacunary structure comprises a plurality of interlaced filaments 17 defining through openings 18.

According to an exemplary embodiment, a gap L1 between two adjacent filaments 17 is comprised between 0.2 mm and 2 mm, or even between 0.2 mm and 1 mm. Below 0.2 mm, the filaments 17 are likely to stick together and therefore make the zone “watertight”, which is contrary to the research objective. In addition, too small a gap hinders the evacuation of the wetting liquid. Beyond 2 mm, the preform could be marked and/or deformed by the mold fibers. A width L2 or a diameter of a filament 17 is for example between 0.2 mm and 1 mm, or even between 0.2 mm and 0.5 mm.

The lacunary structure may comprise a plurality of first parallel filaments 17 extending in a first direction D1 and a plurality of second parallel filaments 17 extending in a second direction D2. In this case, the first direction D1 and the second direction D2 form an angle of about 90 degrees. Alternatively, the directions D1 and D2 may form an angle of 45 degrees or any other non-zero angle suitable for the application. The gap L1 may be measured between two adjacent filaments 17 extending in the direction D1 or between two adjacent filaments 17 extending in the direction D2.

Thanks to the presence of the through openings 18 between the filaments 17, the part 11 allows internal circulation of the wetting liquid from at least one internal face to at least one external face opposite the internal face of the part 11. In other words, the wetting liquid can pass right through the part 11.

Furthermore, the part 12 having a rigid structure comprises two opposite and parallel side walls 21.1, 21.2. The side walls 21.1, 21.2 are connected to each other by two other opposite and parallel side walls 21.3, 21.4.

The internal faces of the walls 21.1, 21.2 of the part 12 are in contact with the external faces of the walls 15.1, 15.2 of the part 11. The internal faces of the walls 21.3, 21.4 are in contact with the external faces of the walls 15.3, 15.4 of the part 11.

The part 12 thus has a parallelepiped shape defining a through opening in the opening direction D of the part 11 having a lacunary structure. Thus, the bottom wall 15.5 of the part 11 opens out on the side of one end of the opening in the part 12.

The part 12 is not necessarily open and may also include a bottom opposite the bottom wall 15.5 of the part 11 having a lacunary structure. However, the more open the configuration of the mold 10 is, the more easily the moisture in the fibrous preform can escape outside the mold 10. In addition, the mold 10 requires less material for its manufacture. It will therefore be faster and less expensive to manufacture.

The part 12 may be made from a solid material. The part 12 does not therefore comprise any internal cavity likely to weaken its structure.

Of course, the mold 10 is not limited to a parallelepiped shape. and may have any other geometric shape suitable for the application.

Advantageously, a pneumatic connector 23 is in fluid communication with the part 11 having a lacunary structure. The pneumatic connector 23 is fixed to the part 12 through which said pneumatic connector 23 passes. In this case, the part 12 defines a sealed envelope surrounding at least partially but preferably completely, the part 11 having a lacunary structure (except in the upper part of the part 11 having a lacunary structure, this open upper part being intended to be closed by a cover). For this purpose, or an external internal wall delimiting the part 12 is sealed. Alternatively, the part 12 is made from a solid material.

The pneumatic connection 23 is connected to a vacuum pump in order to extract the wetting liquid from the preform via the part 11. This liquid vacuum extraction can be carried out in addition to the hot drying or mechanical wringing process linked to the compaction force applied to the wet fibrous preform.

Depending on the desired drying level, the vacuum draw is not essential. In fact, it is possible to carry out only drying, for example at a temperature above 100° C. to reach a boiling temperature of water, without using the pneumatic connection 23.

Alternatively, it is possible to carry out a drying process at the same time as a compacting process by means of a counterform pressing the fibrous preform against the mold 10.

For an optimum drying level, it is possible to carry out a drying process with a vacuum draw through the mold 10. Such an embodiment requires closing the mold 10 and providing a vacuum pocket around the mold 10 so that the vacuum can extract the wetting liquid from the fibrous preform. Alternatively, it is possible to use a cover and a seal attached to the upper face of the part 12 in the case where the part 12 includes a sealed bottom or is fixed to such a bottom.

Advantageously, the part 11 having a lacunary structure and the part 12 having a rigid structure form a single piece. These two parts 11 and 12 are integral with each other, and in a fixed manner. There may be continuity of material between the part 11 and the part 12. In particular, there may be a continuity of material between the filaments 17 in the part 11 and the filaments 17 in the part 12. To make the part 11 having a lacunary structure, the filaments 17 are intertwined and spaced apart as previously indicated. To make the part 12 with a rigid structure, the filaments 17 are arranged edge to edge so as to get a solid material or are spaced apart by a very small gap (less than 0.2 mm for example).

Preferably, the entire mold 10, or at least the part 11 having a lacunary structure, is made from an amorphous thermoplastic polyetherimide resin, known as PEI. Advantageously, the material used is a material of the Ultem 1010 type (registered trademark) because its glass transition temperature (Tg) of 215° C. is compatible with the drying temperature of about 100° C. In addition, this material has good mechanical properties. Alternatively, it is possible to use a material of the Ultem 9085 type (registered trademark) with a glass transition temperature (Tg) of 185° C.

The mold 10, or at least the part 11 having a lacunary structure, is preferably obtained by an additive manufacturing process by deposition of filaments 17. Such a manufacturing process is intrinsically well suited to the part to be manufactured, insofar as the production of the different rows of filaments can be carried out one after the other by successive addition of material. Alternatively, the mold 10 can be produced by metal additive manufacturing in lattices for example or by any other manufacturing process adapted to the application.

Alternatively, the part 12 having a rigid structure is made from a metallic material, such as aluminum, or a plastic material.

It should be noted that, in certain cases, the mold 10 can only be used to dry the fibrous preform, without suction or pressing other than necessary for introducing the fibrous preform into the mold 10.

The invention further relates to a method for drying a fibrous preform comprising at least one step of placing the fibrous preform inside a drying mold 10.

Of course, different characteristics, variants and/or embodiments of the present invention may be associated with each other in various combinations insofar as they are not incompatible with or exclusive of one another.

Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1. A method for drying a fibrous perform, the method comprising at least one step of placing the fibrous preform into a mold for drying a fibrous preform comprising at least one part comprising internal faces defining an imprint of the mold with which the fibrous preform wetted by a wetting liquid comes into contact so as to be shaped, said part having a lacunary structure allowing passage of the wetting liquid through said part of said mold, the part having a lacunary structure comprising a plurality of intersecting filaments defining through openings for the passage of the wetting liquid.

2. The method according to claim 2, wherein a gap between two adjacent filaments is comprised between 0.2 mm and 2 mm, or even between 0.2 mm and 1 mm.

3. The method according to claim 1, wherein the mold is obtained by an additive manufacturing process by deposition of filaments.

4. The method according to claim 1, wherein the mold further comprises a part having a rigid structure around the part having a lacunary structure.

5. The method according to claim 4, wherein the part having a rigid structure has a higher density than the part having a lacunary structure.

6. The method according to claim 4, wherein the part having a rigid structure is made from a solid material.

7. The method according to claim 4, wherein the part having a lacunary structure and the part having a rigid structure form a single piece.

8. The method according to claim 4, wherein the mold comprises a pneumatic connection in fluid communication with the part having a lacunary structure, the part having a rigid structure defining a sealed envelope at least partially surrounding the part having a lacunary structure.

9. The method according to claim 1, characterized in that the part having a lacunary structure is made from amorphous thermoplastic polyetherimide resin.
